(19) United States
(12) Patent Application Publication
(10) Pub. No.: US 2025/0054032 A1
(43) Pub. Date: Feb. 13, 2025

(54) INFORMATION PROCESSING APPARATUS

(71) Applicant: TOYOTA JIDOSHA KABUSHIKI KAISHA, Aichi-ken (JP)

(72) Inventor: Atsushi HIGAKI, Nishi-Tokyo City (JP)

(21) Appl. No.: 18/791,430

(22) Filed: Aug. 1, 2024

(30) Foreign Application Priority Data
Aug. 10, 2023 (JP) 2023-131567

(51) Int. Cl. G06Q 30/0283

(52) U.S. Cl. CPC G06Q 30/0283

(57) ABSTRACT

In an information processing apparatus, a controller receives input of an information including a type of a vehicle desired by a user, an options desired by the user, and a payment terms for acquiring the right to use the vehicle. In response to the receiving input of the information including the type of the vehicle desired by the user, the options desired by the user, and the payment terms for the fees to acquire the right to use the vehicle, the controller outputs an information comparing the payment amounts including maintenance fees for plurality of payment methods.

### CROSS REFERENCE TO THE RELATED APPLICATION

This application claims the benefit of Japanese Patent Application No. 2023-131567, filed on Aug. 10, 2023, which is hereby incorporated by reference herein in its entirety.

### BACKGROUND

### Technical Field

The present disclosure relates to an information processing apparatus.

### Description of the Related Art

There is known a technology for displaying the total payment amount and monthly payment amount when purchasing a vehicle in a manner that allows comparison between installment payments and leasing (see, for example, Patent Literature 1).

### CITATION LIST

### Patent Literature

Patent Literature 1: Japanese Patent Application Laid-Open No. 1999-25164

### SUMMARY

An object of the present disclosure is to provide a technology that can provide a user with more accurate information regarding the costs involved with a vehicle.

In one aspect of the present disclosure, there is provided an information processing apparatus. For example, the information processing apparatus may comprise a controller including at least one processor that is configured to execute processing of:
receiving an input of an information including a type of a vehicle desired by a user, an option of the vehicle desired by the user, and a payment terms for acquiring a right to use the vehicle desired by the user; and
outputting an information comparing payment amounts including a maintenance fees for a plurality of payment methods, in response to the receiving the input.

The present disclosure can also be regarded as an information processing method in which a computer executes the processing of the information processing apparatus. Further, the present disclosure can also be regarded as a program for causing a computer to execute the information processing method described above, or as a non-transitory storage medium for storing the program.

According to the present disclosure, it is possible to provide a technology that can provide a user with more accurate information regarding vehicle costs.

### BRIEF DESCRIPTION OF THE DRAWINGS

FIG. 1 is a diagram illustrating an outline of a system according to an embodiment.

FIG. 2 is diagram illustrating a first example of a supporting Web page.

FIG. 3 is diagram illustrating a second example of a supporting Web page.

FIG. 4 is a flowchart illustrating a flow of processing executed by the server according to the embodiment.

### DESCRIPTION OF THE EMBODIMENTS

There are several ways in which a user can pay to obtain the right to use a vehicle: paying the purchase price of the vehicle in installments (installment payments), paying the purchase price in installments minus the residual value at the end of the payment period (residual value loan), or paying a monthly fees that includes maintenance fees (lease). It is conceivable that the payment amounts for these plurality of payment methods may be output to a business operator's terminal or the like in a comparable form. The business operator referred to here is, for example, a provider of vehicle sales or leasing services (for example, an employee of a car dealership, etc.).

Incidentally, the maintenance fees borne by the user during the payment period may differ among the above-mentioned plurality of payment methods. For example, leasing services allow users to use a vehicle by paying a monthly fees that includes maintenance fees. In the case of installment payments and residual value loans, the user may be required to pay maintenance fees in addition to the installment payments and residual value loan payments. Note that “maintenance fees” in the present disclosure includes costs for maintenance of the vehicles (e.g., statutory inspection costs, vehicle inspection costs, replacement costs for consumable parts, and repairs), automobile insurance premiums, taxes, etc., but does not include rental fees for vehicle storage space.

Accordingly, a method is needed to make it possible to compare the amounts paid by plurality of payment methods, taking into account any maintenance fees that users may be required to pay separately during the payment period.

Therefore, in the information processing apparatus of the present disclosure, the controller is configured to accept input of the information including the type of the vehicle desired by the user, options desired by the user, and payment terms for the fees for obtaining the right to use the vehicle. The information processing apparatus according to the present disclosure may be a terminal used by a business operator providing vehicle sales and/or leasing services, or a Web server connected to the business operator's terminal via a communication network.

Options are equipment that can be added to the vehicle at additional cost. The payment terms are the payment period (e.g., the number of years) and the bonus addition amount. Note that option selections may vary depending on the payment method. For example, installment payments tend to offer more options because there is no need to consider the residual value of the vehicle at the end of the payment period. In contrast, with residual value loans and leases, the vehicle returned by the user at the end of the payment period must be sold or leased as a used car, so the residual value of the vehicle at the end of the payment period must be taken into consideration. Therefore, with residual value loans and leases, option selections tend to be limited to only those that are in high demand in the used car market.

Therefore, the controller may be configured to allow the user to select a desired option from among the options corresponding to the payment method that has the fewest option selections among the plurality of payment methods. As an example, the controller may be configured to output an user interface screen including an input field for the type of the vehicle, a selection field for allowing the user to select a desired option from option selections corresponding to a payment method having the most limited option selections among the plurality of payment methods, and an input field for payment terms.

In response to receiving the input of the above information, the controller outputs an information comparing payment amounts including maintenance fees, for a plurality of payment methods. As an example, the plurality of payment methods may be an installment payments, a residual value loans, and a leases. As another example, the maintenance fees may be an insurance premiums for the vehicle desired by the user, a costs for maintenance of the vehicles desired by the user, and a taxes levied on the vehicle desired by the user. In addition, the outputting information comparing payment amounts including the maintenance fees for the plurality of payment methods may include an outputting a user interface screen including, for each of the plurality of payment methods, a monthly payment amount (monthly fees), a maintenance fees, and a total payment amount for the payment period. Note that, in a case where the information processing apparatus according to the present disclosure is a Web server connected to the terminal of the business operator via a network, the outputting information comparing payment amounts including the maintenance fees for the plurality of payment methods may include an outputting a user interface screen (Web page) including the monthly payment amount for each of the plurality of payment methods, the maintenance fees, and the total payment amount for the payment period, to a Web browser of the terminal.

According to the information processing apparatus of the present disclosure, the business operator can obtain the information comparing payment amounts including the maintenance fees, for the plurality of payment methods by inputting the type of the vehicle desired by a user and the payment terms into the information processing apparatus. This allows the business operators to present users with the information comparing payment amounts including the maintenance fees for the plurality of payment method.

Hereinafter, specific embodiments of the present disclosure will be described with reference to drawings. The hardware configuration, module configuration, functional configuration, etc. described in the following embodiments are not intended to limit the technical scope of the present disclosure to those only them, unless otherwise stated.

### EMBODIMENT

An embodiment of the present disclosure will be described with reference to figures. In this embodiment, an example will be described in which the information processing apparatus according to the present disclosure is applied to a system that provides vehicle sales and leasing services. The leasing service is a service (also known as a subscription service) in which a user pays a monthly fees each month during a payment period specified in a contract, thereby obtaining the right to use a vehicle for that payment period. The leasing service contract also includes a maintenance fees during the payment period.

### (System Configuration)

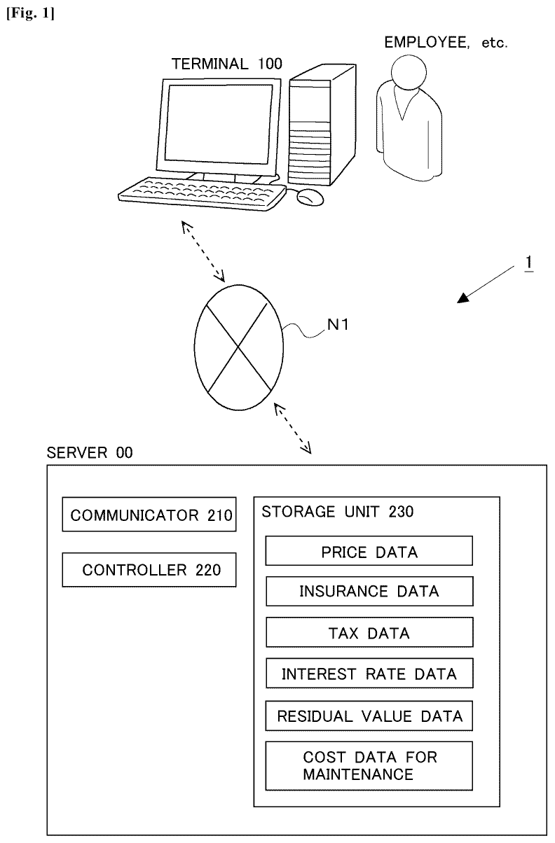

FIG. 1 is a block diagram schematically illustrating an example of a configuration of the system according to this embodiment. The system 1 in this embodiment includes a terminal 100 and a server 200. In the example illustrated in FIG. 1, only one terminal 100 is illustrated, but a plurality of terminals 100 may be included in the system 1.

The terminal 100 is a terminal used by a business operator providing the vehicle sales and leasing services (for example, an employee of a car dealer). The terminal 100 is a computer on which a Web browser application program is installed, such as a smartphone, a mobile phone, a tablet terminal, a wearable device, or a personal computer. In this embodiment, the business operator accesses the server 200 through the terminal 100 to obtain a support information. The support information includes a suggestion as to what it will cost the user to obtain the right to use the vehicle. In this embodiment, the suggestion includes information comparing a plurality of payment methods.

Note that the plurality of payment methods in this embodiment includes a method of paying the purchase price of a vehicle in installments (installment payments), a method of paying the purchase price minus the residual value at the end of the payment period in installments (residual value loan), and a method of paying a monthly fees that includes the maintenance fees (leasing).

Next, the server 200 is an information processing apparatus operated by a company (for example, a vehicle manufacturer or an affiliated company of the manufacturer) that outsources a vehicle sales and a leasing operations to the business operator. The server 200 can be configured as a computer equipped with a processor such as a CPU or GPU, a main memory such as a RAM and a ROM, and an auxiliary memory such as an EPROM, a hard disk drive, or a removable medium. The auxiliary memory of the server 200 stores an operating system (OS), various programs, various tables, and the like. The processor of the server 200 loads the program stored in the auxiliary memory into a working area of the main memory and executes it to realize various functions that meet specific purposes, as described below. Note that, some or all of the functions of the server 200 may be realized by a hardware circuit such as an application specific integrated circuit (ASIC) or a field programmable gate array (FPGA).

The server 200 in this embodiment is configured to be capable of implementing a Web server for interacting with the terminal 100. The server 200 provides the support information to the business operator by interacting with the terminal 100 through the execution of the Web server. The server 200 may provide the above-mentioned services by means other than the Web server. For example, the server 200 may execute a service for interacting with a dedicated application software installed in the terminal 100 by a prescribed protocol.

The server 200 that realizes the above-mentioned functions includes a communicator 210, a controller 220, and a storage unit 230, as illustrated in FIG. 1.

The communicator 210 is a communication interface for connecting the server 200 to a communication network N1. The communicator 210 is connected to the communication network N1 via, for example, a LAN or a Wi-Fi (registered trademark), and communicates with the terminal 100 via the communication network N1. The network N1 is, for example, a WAN which is a world-wide public communication network such as an Internet, or other communication network.

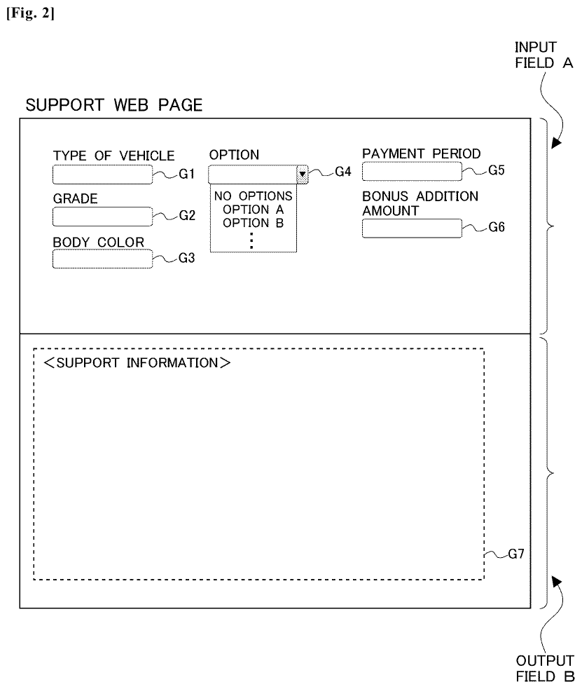

The controller 220 is a software module that is realized by the processor of the server 200 executing the program stored in the auxiliary memory. The controller 220 interacts with the terminal 100 through the execution of a Web server. In this embodiment, the controller 220 causes a support Web page to be displayed on a Web browser of the terminal 100. FIG. 2 is diagram illustrating a first example of the supporting Web page according to this embodiment. The support Web page includes an input field A and an output field B, as illustrated in FIG. 2.

The input field A is a field for the user to enter information about the desired vehicle, and includes following input items.
(Input item 1) A type of the vehicle desired by the user (GUI part G1 in FIG. 2)
(Input item 2) A grade of the vehicle desired by the user (GUI part G2 in FIG. 2)
(Input item 3) A vehicle body color desired by the user (GUI part G3 in FIG. 2)
(Input item 4) An Option desired by the user (part G4 in FIG. 2)
(Input item 5) A Payment period desired by the user (GUI part G5 in FIG. 2)
(Input item 6) A Bonus addition amount desired by the user (GUI part G6 in FIG. 2)

Here, the input item 4 is configured to be selected from among a plurality of option selections displayed in a pull-down menu, as illustrated in FIG. 2. The option selections available may vary depending on the payment method. For an example, the installment payments offer greater flexibility in the option selections since there is no need to consider the residual value of the vehicle at the end of the payment period. In contrast, regarding the residual value loans and the leases, the vehicle returned by the user at the end of the payment period must be sold or leased as a used car, so the residual value of the vehicle at the end of the payment period must be taken into consideration. Therefore, regarding the residual value loans and the leases, the option selections may be limited to only those options that are in high demand in the used car market. If the option selections differ depending on the payment method for such reasons, the option selections displayed in the pull-down menu of the input item 4 are set to the same as the option selections corresponding to the payment method with the most limited options selection among the plurality of payment methods. As an example, it may be set to the same option selections as the residual value loan or the lease. This makes it possible to make the option selections the same even if the option selections differ among the plurality of payment methods.

The bonus addition amount in the input item 6 is a payment amount added to a monthly fees for bonus months (e.g., January and August) specified in the contract. Note that, 0 yen (no bonus addition amount) may be enter in the input item 6.

The output field B is a field for outputting the support information according to the input contents of the input items 1-6 above, and includes a following output items.
(Output item 1) Support information (GUI part G7 in FIG. 2)

On the support Web page, when the business operator providing the vehicle sales and the leasing services enters the information into each of the input items 1-6, the controller 220 calculates the payment amount for each of the plurality of payment methods based on the information entered into the input items 1-6 and a data stored in the storage unit 230 described below. In an example, the controller 220 calculates, for each of the plurality of payment methods, the monthly payment amount (monthly fees), the maintenance fees required during the payment period, and the total payment amount during the payment period. The “total payment amount” here refers to a total amount including a total monthly payment amounts during the payment period, a total bonus addition amount during the payment period, and a maintenance fees required during the payment period.

In this embodiment, the maintenance fees include an automobile insurance premiums incurred during the payment period, a costs for maintenance of the vehicles incurred during the payment period (e.g., a legal inspection costs, a vehicle inspection costs, a replacement costs for consumable parts, and a repairs, etc.), a taxes incurred during the payment period, etc. However, the maintenance fees in this embodiment do not include a rental fees for a vehicle storage space and a fuel costs.

Note that, until entering of the input items 1-6 in the input field A is completed, the output item 1 in the output field B will be blank as illustrated in FIG. 2.

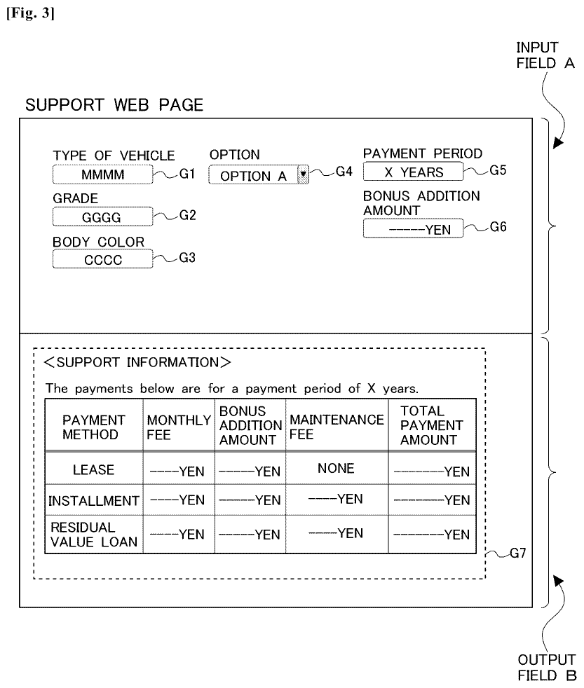

When the payment amount for each of the plurality of payment methods has been calculated, the controller 220 generates the support information to be displayed in the output field B, and causes the generated support information to be displayed in the output field B of the support Web page. The support information is an information that compares payment amounts including maintenance fees for the plurality of payment methods. In an example, the supporting information may be a comparison table of the monthly fees, the bonus addition amount, the maintenance fees, and the total payments for the plurality of payment methods, as illustrated in FIG. 3. In the comparison table illustrated in FIG. 3, the maintenance fees for the leasing is set to “none” (0 yen). This is because the lease service contract in this embodiment includes the maintenance fees during the payment period (contract period).

When the support Web page such as that illustrated in FIG. 3 is displayed through the Web browser of the terminal 100, the business operator can grasp the information (support information) comparing payment amounts including the maintenance fees for the plurality of payment methods by looking at the display contents of the output item 1 (GUI part G7 in FIG. 3) in the output field B. This allows the business operator to present the grasped support information to the user. As a result, the user can get a more accurate picture of the costs that will be incurred during the payment period for the plurality of payment methods.

The configuration of the support Web page is not limited to the examples illustrated in Fig. FIGS. 2 and 3, and the input items and the output items can be flexibly changed depending on a practical situation. Furthermore, the input field A and the output field B do not have to be displayed on a same Web page, and may be displayed on separate Web pages.

Returning now to the explanation of FIG. 1, the storage unit 230 of the server 200 will be described. The storage unit 230 in this embodiment is a logical storage area constructed in the auxiliary memory of the server 200. As illustrated in FIG. 1, the storage unit 230 in this embodiment stores various data used to calculate the payment amounts for the plurality of payment methods. In an example, the storage unit 230 stores a price data, an insurance data, a tax data, an interest rate data, a residual value data, a cost data for maintenance, and the like.

The price data includes a vehicle's base price, a lease price, an option price, and the like. These prices are stored by a grade of each type of the vehicle. The lease prices included in the price data are stored by the length of the payment period (the lease period: for example, 3 years or 5 years). The insurance data includes a monthly insurance premiums by the grade for each type of the vehicle. The tax data includes a tax amounts by the grade for each type of the vehicle. The tax amount included in the tax data is a total amount of the tax levied during the payment period, and is categorized according to the length of the payment period (e.g., 3 years, 5 years, etc.). The interest rate data includes an interest rates by the grade for each type of the vehicle. The interest rate included in the interest rate data may be divided into the interest rate for the installment payments and the interest rate for the residual value loan. The residual value data includes a future (at the end of the payment period) residual values for each type of a vehicle. The residual values included in the residual value data are classified according to the length of the payment period (e.g., 3 years, 5 years, etc.). The residual value of each type of the vehicle may be categorized according to the grade, the body color, and the options. The cost data for maintenance includes the costs for maintenance of the vehicles by the grade for each type of the vehicle. The costs for maintenance of the vehicle included in the cost data for maintenance are categorized according to the length of the payment period (e.g., 3 years or 5 years). In addition, the costs for maintenance of the vehicle included in the cost data for maintenance may be classified according to the options.

### (Process Performed in Server)

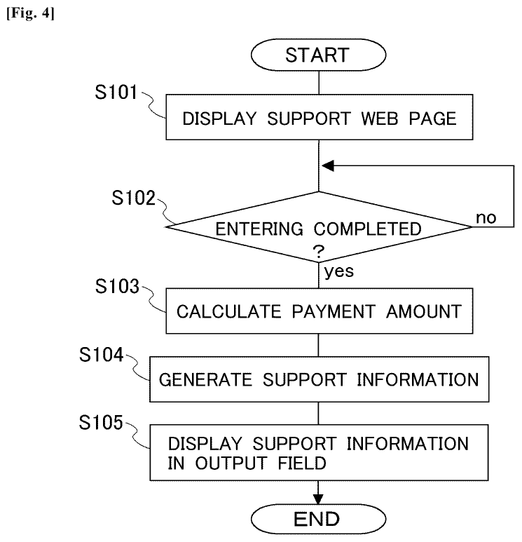

A process flow executed by the server 200 in this embodiment will be described with reference to FIG. 4. FIG. 4 is a flowchart illustrating a processing routine executed by the server 200 when the business operator accesses the URL of the support Web page through the Web browser of the terminal 100. Although the processing routine of FIG. 4 is executed by the processor of the server 200, the following description will be given assuming that the functional components of the server 200 are executing entities.

When the business operator accesses the URL of the support Web page through the Web browser of the terminal 100, the controller 220 of the server 200 causes the Web browser of the terminal 100 to display the support Web page (see FIG. 2) in which the output field B is blank (step S101). After completing the process of step S101, the controller 220 executes a process of step S102.

In step S102, the controller 220 determines whether entering for the input items 1-6 in the input field A on the support Web page has been completed. If the entering for the input item 1-6 has not been completed (a negative determination in step S102), the controller 220 waits until the entering for the input item 1-6 has been completed. If the entering for the input item 1-6 has been completed (positive determination in step S102), the controller 220 executes a process of step S103.

In step S103, the controller 220 calculates the payment amount for the each of the plurality of payment methods. Regarding the payment amount of the lease, the controller 220 obtains from among the lease prices included in the price data of the storage unit 230 the lease price that corresponds to the type of the vehicle entered in the input item 1 (G1 in Fig. Fig. ), the grade entered in the input item 2 (G2 in FIG. 2), and the payment period entered in the input item 5 (G5 in FIG. 2). In addition, the controller 220 obtains from among the option prices included in the price data of the storage unit 230 the option price corresponding to the type of the vehicle entered in the input item 1 (G1 in FIG. 2), the grade entered in the input item 2 (G2 in FIG. 2), and the option entered in the input item 4 (G4 in FIG. 2). The controller 220 calculates the total payment amount of the lease by adding the option price to the lease price. The controller 220 calculates the monthly payment amounts of the lease by subtracting the total bonus addition amount (the sum of the bonus addition amounts during the payment period) from the total payment amount of the lease and dividing the subtraction result by the number of the months in the payment period.

Regarding the amount of the installment payments, the controller 220 obtains the base price corresponding to the type of the vehicle entered in the input item 1 (G1 in FIG. 2) and the grade entered in the input item 2 (G2 in FIG. 2) from among the base prices included in the price data of the storage unit 230. In addition, the controller 220 obtains the option price corresponding to the type of the vehicle entered in the input item 1 (G1 in FIG. 2), the grade entered in the input item 2 (G2 in FIG. 2), and the option entered in the input item 4 (G4 in FIG. 2) from among the option prices included in the price data of the storage unit 230. Furthermore, the controller 220 obtains, from among the interest rates included in the interest rate data of the storage unit 230, the interest rate corresponding to the type of the vehicle entered in the input item 1 (G1 in FIG. 2) and the grade entered in the input item 2 (G2 in FIG. 2). Note that, if the interest rates for the installment payments and for the residual value loans are distinguished, the controller 220 obtains the interest rate that applies to the installment payments from among the interest rates that correspond to the type of the vehicle entered in the input item 1 (G1 in FIG. 2) and the grade entered in the input item 2 (G2 in FIG. 2). The controller 220 adds the option price to the base price. The controller 220 calculates the total amount of the installation payments excluding the maintenance fees and the monthly amount of the installation payments based on the base price plus the installment payments price, the maintenance fees, the interest rate, the number of the months in the payment period entered in the input item 5 (G5 in FIG. 2), and the bonus addition amount entered in the input item 6 (G6 in FIG. 2). Such calculations may be performed according to known methods.

Also, the controller 220 obtains the monthly insurance premiums corresponding to the type of the vehicle entered in the input item 1 (G1 in FIG. 2) and the grade entered in the input item 2 (G2 in FIG. 2) from among the monthly insurance premiums included in the insurance data of the storage unit 230. The controller 220 calculates the total amount of the monthly insurance premiums during the payment period by multiplying the obtained monthly insurance premium by the number of the months of the payment period entered in the input item 5 (G5 in FIG. 2). In addition, the controller 220 obtains the tax amount corresponding to the type of the vehicle entered in the input item 1 (G1 in FIG. 2), the grade entered in the input item 2 (Fig. in FIG. 2), and the payment period entered in the input item 5 (G5 in FIG. 2) from among the tax amounts included in the tax data in the storage unit 230. Furthermore, the controller 220 obtains the costs for maintenance of the vehicle from among the costs for the maintenance of the vehicle included in the cost data for maintenance of the storage unit 230 that correspond to the type of the vehicle entered in the input item 1 (G1 in Fig. Fig. ), the grade entered in the input item 2 (G2 in FIG. 2), and the payment period entered in the input item 5 (G5 in FIG. 2). Note that, if the costs for maintenance of the vehicle included in the cost data for maintenance are categorized according to the options, the controller 220 may obtain the costs for maintenance of the vehicle corresponding to the type of the vehicle, the grade, the payment period, and the option selected in the input item 4 (G4 in FIG. 2) from among the cost data for maintenance of the storage unit 230. The controller 220 calculates the maintenance fees for the installment payments by adding the tax amount and the costs for maintenance of the vehicle to the total monthly insurance premiums. Further, the controller 220 calculates the total payment amount of the installment including the maintenance fee by adding the maintenance fee for the installment payments to the total payments amount of the installment excluding the maintenance fee.

Next, with regard to the payment amount of the residual value loan, the controller 220 obtains the base price, the option price, and the interest rate in the same manner as in the case of the installment payments. In addition, the controller 220 obtains the residual value corresponding to the type of the vehicle entered in the input item 1 (G1 in FIG. 2) and the payment period entered in the input item 5 (G5 in FIG. 2) from the residual value data in the storage unit 230. Note that, in a case where the residual values included in the residual value data are categorized according to the grade, the body color, and the options, the controller 220 may obtain the residual value corresponding to the type of the vehicle entered in the input item 1 (G1 in FIG. 2), the grade entered in the input item 2 (G2 in FIG. 2), the body color entered in the input item 3 (G3 in FIG. 2), the option selected in the input item 4 (G4 in FIG. 2), and the payment period entered in the input item 5 (G5 in FIG. 2) from the residual value data in the storage unit 230. The controller 220 subtracts the residual value from the total amount of the base price and the option price. The controller 220 calculates the total payment amount for the residual value loan excluding the maintenance fees and the monthly amount for the residual value loan, based on the price obtained by subtracting the residual value from the sum of the base price and the option price, the interest rate, the number of months for the payment period entered in the input item 5 (G5 in FIG. 2), and the bonus addition amount entered in the input item 6 (G6 in FIG. 2). Such calculations may be performed according to known methods.

Furthermore, the controller 220 calculates the maintenance fee for the residual value loan in the same manner as in the case of installment payments. Furthermore, the controller 220 calculates the total payment amount for the residual value loan including the maintenance fee by adding the maintenance fee for the residual value loan to the total payment amount for the residual value loan excluding the maintenance fee.

When the controller 220 has finished calculating the payment amounts for the each of the plurality of the payment methods in the above-described procedure (when the controller 220 has finished executing the process of step S103), the controller 220 executes a process of step S104. In step S104, the controller 220 generates the support information to be displayed in the output item 1 of the output field B. As an example, the controller 220 generates a comparison table of the monthly payments, the bonus addition amount, the maintenance fees, and the total payments (the total payments including the maintenance fees) for the plurality of the payment methods (leases, installment payments, and residual value loans) as the supporting information. After completing the process of step S104, the controller 220 executes a process of step S105.

In step S105, the controller 220 displays, via the Web browser of the terminal 100, a support Web page (see FIG. 3) in which the support information generated in step S104 is displayed in the output item 1 of the output field B. When the controller 220 has completed executing the process of step S105, the controller 220 ends the execution of the processing routine of FIG. 4.

### Operation and Advantageous Effects of the Embodiments

According to the embodiment described above, the business operator can obtain an information (support information) comparing the payment amounts including the maintenance fees for the plurality of the payment methods by inputting the type of the vehicle desired by the user and the payment terms on the support Web page. This allows the business operator to present the grasped support information to the user. As a result, the user can get a more accurate picture of the costs that will be incurred over the payment period for the plurality of the payment methods.

In this embodiment, the server 200 corresponds to the “information processing apparatus” according to the present disclosure. Also, the controller 220 of the server 200 corresponds to the “controller” according to the present disclosure. Furthermore, the support Web page in this embodiment corresponds to the “interface screen” according to the present disclosure.

### <Others>

The above-described embodiment is merely an example, and the present disclosure can be modified and implemented as appropriate without departing from the scope of the present disclosure. As an example, the processing performed by the server 200 may be performed by the terminal 100. In other words, the terminal 100 may execute a dedicated application program to output an interface screen including the input field A and the output field B, calculate the payment amounts including maintenance fees for the plurality of the payment methods, and output the support information. In this case, the terminal 100 corresponds to the “information processing apparatus” according to the present disclosure. Also, the “controller” according to the present disclosure is achieved by the processor of the terminal 100 executing the dedicated application program.

Furthermore, the processes and the configurations described in the present disclosure can be freely combined and implemented as long as no technical contradictions arise. Also, the processing described as being executed by one apparatus may be executed by a plurality of apparatuses. In addition, the processing described as being executed by different apparatuses may be executed by one apparatus. In a computer system, the hardware configuration that implements each function can be flexibly changed.

What is claimed is:

1. An information processing apparatus comprising a controller including at least one processor that is configured to execute processing of:
receiving an input of an information including a type of a vehicle desired by a user, an option of the vehicle desired by the user, and a payment terms for acquiring a right to use the vehicle desired by the user; and
outputting an information comparing payment amounts including a maintenance fees for a plurality of payment methods, in response to the receiving the input.

2. The information processing apparatus according to the claim 1, wherein,
the payment terms include a payment period, and a bonus addition amount.

3. The information processing apparatus according to the claim 1, wherein,
the maintenance fees include an insurance premiums for the vehicle, a cost for maintenance of the vehicle, and a taxes for the vehicle.

4. The information processing apparatus according to the claim 1, wherein,
the receiving the input includes outputting a user interface screen including an input field for a type of the vehicle, a selection field for allowing the user to select a desired option from among option selections corresponding to a payment method having the most limited option selections among the plurality of payment methods, and an input field for the payment terms.

5. The information processing apparatus according to the claim 1, wherein,
the plurality of the payment methods include an installment payments, a residual value loan, and a lease.
